(19) United States
(12) Patent Application Publication
(10) Pub. No.: US 2018/0103113 A1
(43) Pub. Date: Apr. 12, 2018

(54) APPARATUS AND METHOD FOR DETERMINING HOUSEHOLD POPULATION FROM NETWORK DEVICE ACTIVITY

(71) Applicant: THOMSON Licensing, Issy-les-Moulineaux (FR)

(72) Inventors: Jaideep Chandrashekar, San Francisco, CA (US); Yun-Jhong Wu, Ann Arbor, MI (US)

(21) Appl. No.: 15/717,178

(22) Filed: Sep. 27, 2017

Related U.S. Application Data
(60) Provisional application No. 62/407,014, filed on Oct. 12, 2016.

(51) Int. Cl. H04L 29/08

(52) U.S. Cl. CPC H04L 67/22; H04L 67/18

(57) ABSTRACT

The present principles generally relate to an apparatus and a method for processing network device activities in a location such as a house or an office building. In one exemplary embodiment, network activities for the devices associated with a location are determined. Devices with correlated periods of network activities are grouped together. The grouped devices are determined to be belonging to the same user and, therefore the population associated with the location can thus be determined.

### CROSS-REFERENCE TO RELATED APPLICATIONS

This application claims the benefit of U.S. Provisional Patent Application Ser. No. 62/407,014, filed Oct. 12, 2016, which is incorporated by reference herein in its entirety.

### TECHNICAL FIELD

The present principles generally relate to an apparatus and a method for processing network device activities in a location such as a house or an office building. In one exemplary embodiment, network activities for the devices associated with a location are determined. Devices with correlated periods of network activities are grouped together. The grouped devices are determined to be belonging to the same user and, therefore the population associated with the location can thus be determined.

### BACKGROUND

This section is intended to introduce a reader to various aspects of art, which may be related to various aspects of the present principles that are described and/or claimed below. This discussion is believed to be helpful in providing the reader with background information to facilitate a better understanding. Accordingly, it should be understood that these statements are to be read in this light, and not as admissions of prior art.

Today's device rich locations such as households are defined by a group of individuals each possessing a set of network devices. These network devices typically include e.g., smartphones, tablets, and other compute devices such as laptops and desktops. A home gateway or a network based gateway which provides connectivity to a network such as Internet for these devices is typically able to monitor the network activities of these devices associated with the location. Since the network activities of these devices may already be monitored, it is therefore advantageous to be able to make further use of the available information to gain insight into the locations or users associated with the devices.

### SUMMARY

The present principles recognize that it would be advantageous to be able to determine the population information (e.g., the number of people) associated with a location easily, without having to perform an actual in-person survey, in order to provide a more efficient and less intrusive methodology. The population information associated with a location is valuable since it may be used for, e.g., network management and planning, target marketing or as a form of automated census. As used herewith, a location may be, e.g., a home, an office, a building, a particular networked area served by one or more gateways such as routers, bridges, Wi-Fi access points, and etc. People associated with a particular location may include, e.g., people who live in and/or use the location, and/or people who are connected to a network defined by the location.

Therefore, the present principles recognize that it would be desirable to be able to determine the number of people associated with a location based on the network activities of the devices being monitored. The present principles further recognize that since these devices are uniquely associated with individuals within a location, the network presence or activities of these devices belonging to a single individual is highly correlated. Therefore, if the devices can be grouped together by the correlation of the devices' network activities, the population associated with a location may be determined without much user intervention or manual effort.

The present principles further recognize that having such information may be useful for various applications. For example, a system or content provider may adapt content being delivered to optimize use of available bandwidth or to deliver content of interest and/or appropriate to users in a location and/or appropriate for the devices in use. In addition, the information may be useful for improving the operation of a system such as set top box, digital television or home network. For example, a system providing a user interface may modify or adapt the user interface to improve presentation of information to a user such as presenting information regarding available content in a more effective or personalized manner based on the devices or users present at a location. The system might allow differentiation between types of devices in a particular location such as a home, e.g., devices associated with specific individuals vs. embedded devices that serve a single purpose (e.g., video cameras, Internet of Things (IoT) devices). Single-purpose devices may be on or active all the time and independent of users being present in the home. Security is a significant concern with IoT devices. Knowing that a device may be or is more likely to be an IoT device rather than a personal device may enable a system such as a home network, e.g., via the Internet gateway, to carry out a number of preventive and mitigating actions to protect against issues such as security concerns, e.g., putting such devices on a separate WiFi network, or applying more restrictive security policies. As another example of use of information regarding users and their devices, a system could enable or facilitate improved administration by treating or managing groups of devices. For example, all the devices associated with a single user could be managed en masse. As a specific example, parental control applications require identifying a specific device and then imposing filters and access control lists (web sites that should not be visited, etc.). The system could extend this by applying such policies on _all_ the devices in a group. For example, rather than specifying “Alice's” iPad, one could associate a set of devices with Alice, and then apply the parental control function on all devices identified in accordance with the present principles as being Alice's personal devices.

Accordingly, an exemplary electronic apparatus for estimating a number of network users using a plurality of network devices associated with a location is presented, comprising: a processor configured to monitor a network for producing a plurality of data entries that are applicable to a plurality of time slots, a given data entry applicable to a corresponding time slot and is used to identify a network device exhibiting network activity during the given time slot; the processor is further configured to estimate the number of network users associated with the location wherein the estimation is based on a result of a correlation analysis to the data entries for determining a number of groups of the plurality of network devices, each group comprising a subset of the plurality of network devices, wherein the subset of the plurality of network devices having among them correlated network activity; and wherein the number of groups being indicative of the number of network users associated with the location; and a memory configured to store the estimated number of network users associated with the location.

In another exemplary embodiment, a method performed by an electronic apparatus for estimating a number of network users using a plurality of network devices associated with a location is presented, comprising: monitoring a network, via a processor, for producing a plurality of data entries that are applicable to a plurality of time slots, a given data entry applicable to a corresponding time slot and is used to identify a network device exhibiting network activity during the given time slot; and estimating, via the processor, the number of network users associated with the location wherein the estimating is based on a result of a correlation analysis of the data entries for determining a number of groups of the plurality of network devices, each group comprising a subset of the plurality of network devices, wherein the subset of the plurality of network devices having among them correlated network activity; and wherein the number of groups being indicative of the number of network users associated with the location.

In another exemplary embodiment, a computer program product stored in a non-transitory computer-readable storage medium is presented, comprising computer-executable instructions for estimating a number of network users using a plurality of network devices associated with a location, comprising: monitoring a network, via a processor, for producing a plurality of data entries that are applicable to a plurality of time slots, a given data entry applicable to a corresponding time slot and is used to identify a network device exhibiting network activity during the given time slot; and estimating, via the processor, the number of network users associated with the location wherein the estimating is based on a result of a correlation analysis of the data entries for determining a number of groups of the plurality of network devices, each group comprising a subset of the plurality of network devices, wherein the subset of the plurality of network devices having among them correlated network activity; and wherein the number of groups being indicative of the number of network users associated with the location.

### BRIEF DESCRIPTION OF THE DRAWINGS

The above-mentioned and other features and advantages of the present principles, and the manner of attaining them, will become more apparent and will be better understood by reference to the following description of embodiments of the present principles taken in conjunction with the accompanying drawings, wherein:

FIG. 1 shows an exemplary embodiment according to the present principles;

FIG. 2 shows another exemplary embodiment according to the present principles; and

FIG. 3 shows an exemplary embodiment comprising a process according to the present principles.

The examples set out herein illustrate exemplary embodiments of the present principles. Such examples are not to be construed as limiting the scope of the present principles in any manner.

### DETAILED DESCRIPTION

The present principles recognize that it would be desirable to determine population information based on the network activities of the devices being monitored. The present principles further recognize that since these devices are uniquely associated with individuals within a location, the network presence or activities of these devices belonging to a single individual is highly correlated. That is, for example, the same individual would turn on and use his or her computer, cellphone, and/or tablet while he or she is at a certain location such as a home or office. Therefore, if the devices associated with that location can be grouped together by the correlation of the devices' network presence and activities, the population information associated with a location may be determined in an automated fashion.

Home internet gateways at home and network gateways at a service provider may monitor and track the network presence of these devices and hence are ideally situated to identify these correlated devices. Therefore, according to the present principles, we present a method to approximately determine the number of individuals in a location such as in e.g., a home. Here, our underlying assumption is that each individual of a household has at least one device that is uniquely owned and operated by them. This may not be true in all cases (e.g., we do not expect infants to have their own device); we only focus on the population that carries at least one networked device. We therefore present an apparatus and method to associate an individual with the devices operated by him or her using the temporal correlation of the network activities of the devices.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventors to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment”, “an embodiment”, “an exemplary embodiment” of the present principles, or as well as other variations thereof, means that a particular feature, structure, characteristic, and so forth described in connection with the embodiment is included in at least one embodiment of the present principles. Thus, the appearances of the phrase “in one embodiment”, “in an embodiment”, “in an exemplary embodiment”, or as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

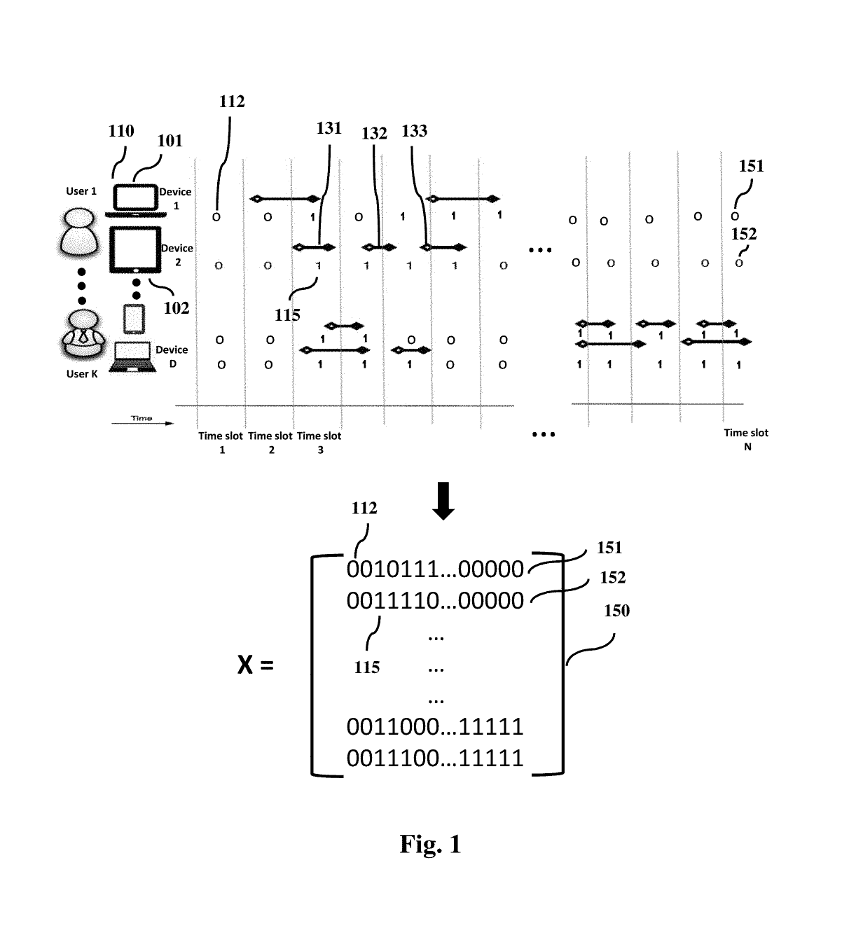

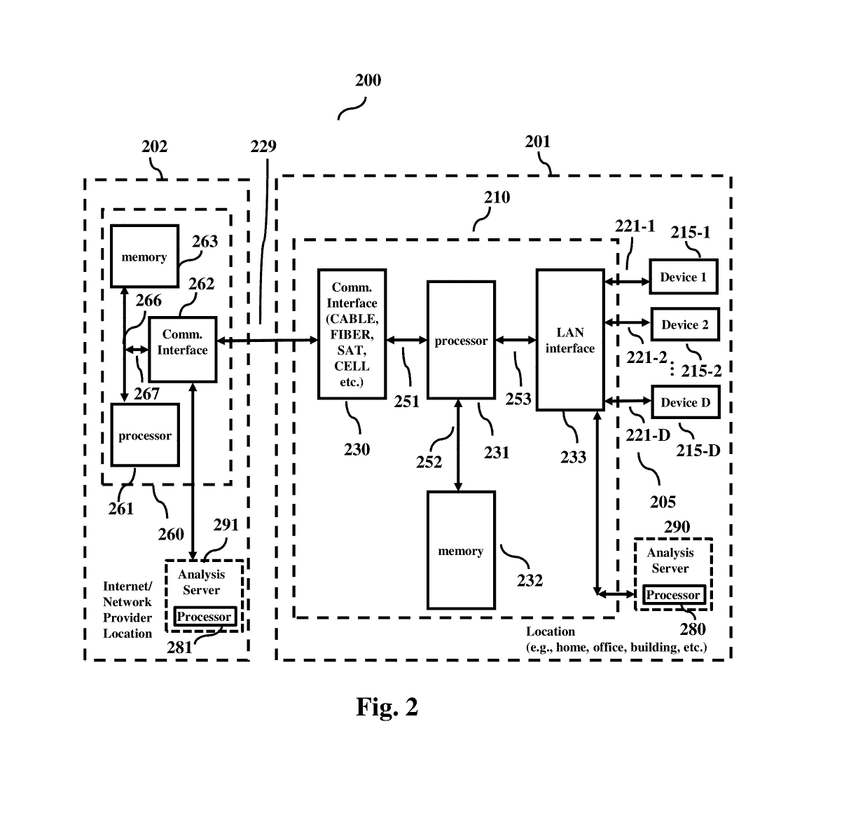

FIG. 2 illustrates an exemplary embodiment in accordance with the present principles. As shown in FIG. 2, a networked system 200 may include a location 201 such as a household or an office with an Internet or network service and may include a LAN 205 comprising a network interface device or apparatus 210 such as a home gateway device, set-top box, digital television, or other device including network interface functionality, and a number of client devices 215-1 to 215-D. These networked client devices may be, e.g., a personal computer (PC) 215-1, a cellphone device 215-2, and a set top box (STB) 215-D. Each client device is connected to a LAN interface 233 of the network interface device 210 via a wired, or wireless, connection as represented by arrows 221-1 to 221-D. Network interface device 210 is also connected to a network via, e.g., a wired, or wireless connection as represented by arrow 229 for sending and receiving data, such as internet protocol (IP) packets to, and from, other servers, endpoints or networks including the Internet. It should be noted that a client device is not limited to the devices illustrated in FIG. 1. Other client devices are possible such as, but not limited to, IPads, IPhones, IPods, Android devices, televisions, printers, and etc. Also, as mentioned above, network interface device 210 may comprise a gateway device, set top box, digital television or other devices including network interface capability such as may comprise e.g., a cable modem, a router, a bridge, a Wi-Fi access point or the like, or one or more of the above combinations, in either wired or wireless communication. In addition, gateway device 210 may also provide communication to one or more LANs (not shown) and not limited to just LAN 205 shown in the illustrated example of FIG. 2.

Also shown in FIG. 2 is an illustrative embodiment of an electronic network interface device or apparatus 210 in accordance with the present principles. For ease of explanation, the following description will refer to network interface device 210 as a gateway device or apparatus. However, such description is intended to be non-limiting and encompass various devices as described above that provide or include network interface capability including gateway devices, set-top boxes, digital televisions, and/or a cable modem, a router, a bridge, a Wi-Fi access point or the like, or one or more of the above combinations, in either wired or wireless communication. Only those portions relevant to explanation of the present principles are shown for brevity. In FIG. 2, gateway device 210 comprises a network communication interface 230, a processor 231, a memory 232 and a LAN interface 233. The various elements of gateway device 210 are coupled together via signaling connections as represented by arrows 251, 252 and 253. Network communication interface 230 couples gateway device 210 to the network cloud (not shown) via a wired, or wireless connection as represented by arrow 229 for sending and receiving data. Likewise, LAN interface 233 couples gateway device 210 to the devices 221-1 to 221-D on the local network 205 via wired, or wireless connections as represented by arrows 221-1 to 221-D for sending and receiving traffic, as described previously.

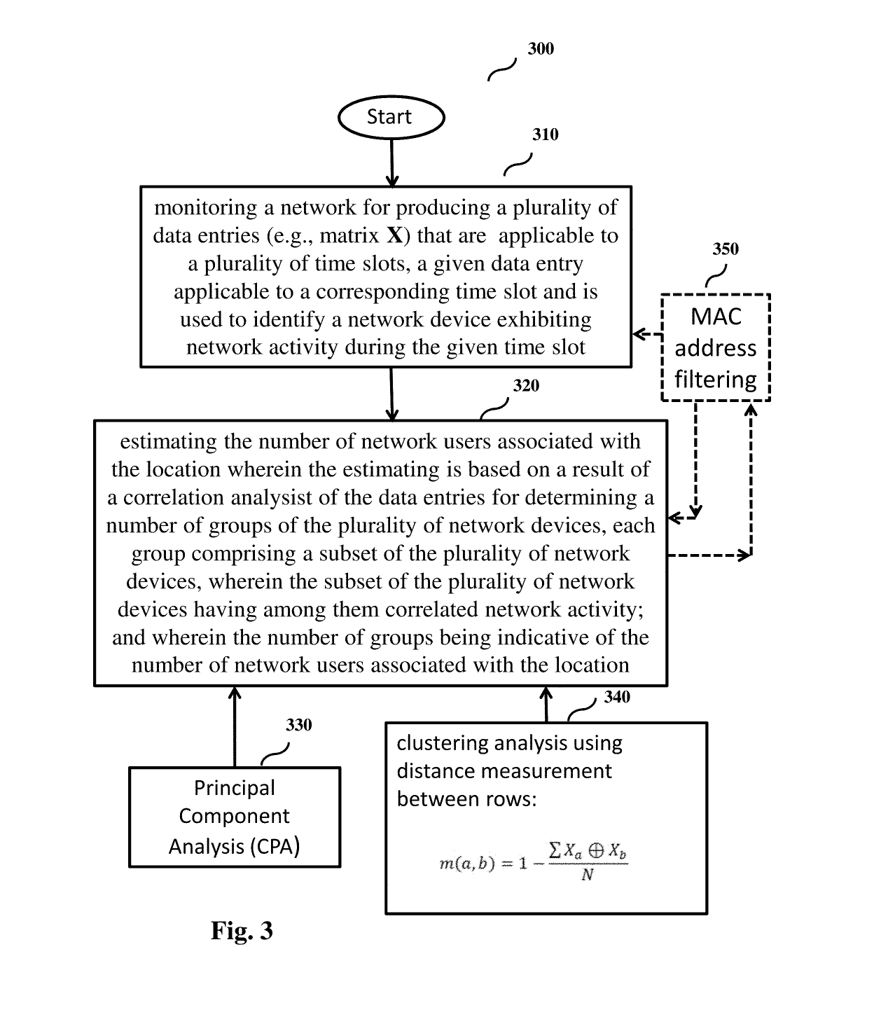

Gateway device 210 is a processor-based device or system and includes one, or more, processors and associated memory (both transitory and non-transitory) as represented by processor 231 and memory 232. In this context, computer programs, or software, (e.g., representing the flow chart of FIG. 3 below) are stored in a non-transitory memory 232 for execution by processor 231. As noted, processor 231 is representative of one, or more, stored-program control processors and these do not have to be dedicated to any one particular function of gateway device 210. That is, e.g., processor 231 may also control other functions of the gateway device 210. Memory 232 is representative of any storage device, e.g., random-access memory (RAM), read-only memory (ROM), etc.; may be internal and/or external to the gateway device; and is volatile and/or non-volatile and transitory and non-transitory, as necessary.

Also shown in FIG. 2 is an exemplary network-based gateway device 260. The network gateway device 260 may perform e.g., traffic routing and network activities monitoring functions according to the present principles. The network gateway device 260 may reside at an exemplary Internet/network provider location 202. Such an Internet/network provider may be, e.g., Comcast cable, Verizon FIOS, AT&T wireless, and etc. The network gateway device 260 is connected to communication interface 230 of the home gateway device 210 of location 201, via a communication interface 262 of the network based gateway device 260. Although not shown in FIG. 2, the same or a different communication interface may be used by device 260 to route the traffic to/from location 201 to/from the Internet through the network gateway device 260.

Additionally, the network gateway device 260 may comprise a processor 261 and a memory 263. The components of the device 260 are interconnected by connections represented by arrows 266 and 267. Device 260 is a processor-based system and includes one, or more, processors and associated memory (both transitory and non-transitory) as represented by processor 261 and memory 263. In this context, computer programs, or software, (e.g., representing the flow chart of FIG. 3 below) are stored in a non-transitory memory 263 for execution by processor 261. As noted, processor 261 is representative of one, or more, stored-program control processors and these do not have to be dedicated to any one particular function of server 260. That is, e.g., processor 261 may also control other functions of the server 260. Memory 263 is representative of any storage device, e.g., random-access memory (RAM), read-only memory (ROM), etc.; may be internal and/or external to the gateway device; and is volatile and/or non-volatile and transitory and non-transitory, as necessary.

Furthermore, an exemplary system 200 shown in FIG. 2 may also comprise analysis servers 290 and 291. These servers 290 and 291 may be connected to gateway devices 210 and 260 respectively in order to obtain network activities information for further analysis as to be described in more detail below. Alternatively, the functionality of servers 290 and 291 may be included in device 260 or device 210, or may be provided by capability in the cloud, or the functionality of servers 290 and 291 may be partially implemented in device 260 and/or device 210 and/or the cloud and/or servers located, e.g., at a head end such as at an Internet service provider (ISP). Each of the analysis servers 290 and 291 may comprise one or more processors, as represented by processors 280 and 281 in FIG. 2. In addition, servers 290 and 291 may include one or more memory (not shown) which may be e.g., random-access memory (RAM), read-only memory (ROM), etc.; may be internal and/or external; and is volatile and/or non-volatile, and transitory and non-transitory, as necessary. In this context, computer programs, or software, (e.g., representing the flow chart of FIG. 3 below) are stored in the non-transitory memory for execution by processor 280 and/or 281, as is well known in the art. Servers 290 and 291 may be, for example, Sun Solaris and Sun UltraSPARC servers capable of running SAS analytic software, as to be further described below. In addition, as mentioned above, the functionality of servers 290 and 291 such as the analysis to be performed as to be described below may also be performed in a device on an end user's premises (e.g., at home), and/or to be performed with an end user's device such as e.g., by a PC, a mobile device, a gateway device, a television, a set top box, and etc.

In accordance with the present principles, a gateway device 210 and/or 260 may implement, e.g., Simple Network Management Protocol (SNMP) to monitor and keep track of network activities or communication traffic on LAN 205. SNMP protocol is a well-known, Internet-standard protocol for monitoring and managing devices on IP networks. Devices that typically support SNMP include routers, switches, servers, workstations, printers, modem racks and more. SNMP is widely used in network management systems to monitor network-attached devices for network activities or conditions that may warrant administrative attention. SNMP is a component of the Internet Protocol Suite as defined by the Internet Engineering Task Force (IETF). It consists of a set of standards for network management and monitoring, including an application layer protocol, a database schema, and a set of data objects. In typical uses of SNMP, one or more administrative computers, called managers, have the task of monitoring or managing a group of hosts or devices on a computer network. Each managed system executes, at all times, a software component called an agent which reports information via SNMP to the manager. Accordingly, an exemplary gateway device 210 and/or an exemplary network server 260 may serve as a SNMP manager to monitor network activities of the devices 221-1 to 221-D in FIG. 2, as to be described in more detail below.

As shown in FIG. 1, in a location 110 (e.g., a home or office), there are typically devices connected to a common gateway 210 or 260 as described above in connection with FIG. 2. These network devices are shown in FIG. 1 as devices 1 to D. A given network device can be considered as being either active or inactive, during a given time slot 1 to N of a statistically large number of consecutive time slots N. The time lot may be for example, 1 minute, 5-minute or 10-minute, and etc. A gateway device 210 or 260 shown in FIG. 2 is capable of identifying whether a given network device is active or inactive, for example, by using SNMP to monitoring network activities of the devices, as described above.

In accordance with an aspect of the present principles, network devices that are active during a given time slot, are statistically more likely to belong to a corresponding group or subset of network devices that are exclusively assigned to an individual associated with the location. In other words, correlated activities among network devices are higher for devices belonging to the same individual than among a mix of network devices belonging to different individuals. This assumption is based on the recognition that the same individual would be most likely to turn on and use at least some or all of her or his devices when, e.g., he or she is at home, while all of his and her devices will have no network activity if the individual is not at home. Therefore, in accordance with the present principles determining the number of individuals associated with the location can be obtained by statistically estimating the number of different highly correlated groups or subsets of the network devices operating in the location, based on their network activities. Although the present principles may be applied to different types of locations as described above, it is recognized that the home environment would probably provide a better result than, e.g., in an office environment. This is because, e.g., most office workers would likely arrive and leave the office at the same time and, therefore, the network activities of some of the devices belonging to different people at an office would probably be inherently more correlated than in a home environment.

According to the present principles and as illustrated in FIG. 1, a matrix X 150 is first constructed in which each entry in a row “D” is associated with a network device “D” and each entry in a column “N” is associated with a time slot “N.” For example, an entry of “1” 115 in row 2, column 3 of the matrix X in FIG. 1 indicates that the network device 2 102 is active at some time during time slot 3 (arrows 131-133 indicate periods of network activities for device 2). Conversely, an entry of “0” 112 in row 1, column 1 indicates that the network device 1 101 is not active anytime during time slot 1. Accordingly, a matrix X 150 is formed as shown in FIG. 1.

Continuing with FIG. 1, let o be the set of all devices associated with a location and for each d ∈ D, we define a column vector X_{d}=(x_{d,1}, x_{d,2}, . . . , x_{d,N}), which corresponds to N time slots 1,2, . . . , N. Then x_{d,i}=1 if device d was active on the network at any time during the time slot i, and 0 otherwise. The width of a time slot is a parameter, and we select it to be, e.g., 10 minutes in an exemplary embodiment. One skilled in the art can readily recognized that this time period may be changed or adjusted based on a plurality of factors, including resource constraints, accuracy of forecast, etc. The time period may also be adjusted dynamically, e.g., based on time of the day, traffic condition on the network, and etc. In general, the accuracy of the present principles is directly tied to the observation window and therefore, N needs to be large. Therefore, X=(X₁, X₂, . . . , X_{|D|})^{T} is a matrix describing the network presence of all the devices associated with a location as described above and shown in FIG. 2.

According to the present principles, an apparatus and method to determine the number of individuals in a home is constructed by finding the number of groups of correlated or highly correlated devices. That is, the devices owned and operated by an individual will be correlated with each other, and less correlated with devices owned by other individuals in the same location. We apply known ways of finding correlations or covariances among a set of variables to the matrix X. One exemplary way is by using Principal Component Analysis (PCA).

As described in the article “Principal Component Analysis for Grouped Data—a Case Study”, Environmentrics, 10, 565-574 (1999), by Thalib, et al., PCA is a statistical technique that provides a linear transformation of an original set of variables into a substantially smaller set of uncorrelated variables, called principal components (PC). PCA represents most of the information in the original set of variables. Much of the variability in the original data can be accounted for by the first few principal components. That is, the first few principal components represent the groups of variables which are highly correlated. Principal component analysis is therefore an analytical technique such that given a data set with p numeric variables, one can compute p principal components. Each principal component is a linear combination of the original variables, with coefficients equal to the eigenvectors of the correlation or covariance matrix. The eigenvectors are customarily taken with unit length. The principal components are sorted by descending order of the eigenvalues, which are equal to the variances of the components.

Also as described in Singular value decomposition and principal component analysis, Ch. 5 of a Practical Approach to Microarray Data Analysis (D. P. Berrar, W. Dubitzky, M. Granzow, eds.) Kluwer: Norwell, Mass., 2003. pp. 91-109. LANL LA-UR-02-4001, one well known way of solving for the principal components of a PCA is to use singular value decomposition (SVD).

Accordingly, to solve the PCA using SVD, we may proceed as follows:
Compute XX^{T} and compute its eigenvector decomposition.
Obtain the singular value decomposition (SVD) of the matrix as UΣV^{T}=XX^{T}.
Let λ₁, λ₂, . . . be the rank ordered eigenvalues obtained, and let λₖ be the last significant eigenvalue. Significance may be determined by looking at the relative values of the eigenvalues using a scree plot as is well known in the art, or by simply picking the corresponding eigenvalues which are greater than a value such as, e.g., 1, and discarding the rest of the principal components. If a significant eigenvalue cannot be determined, then the procedure fails, and no correlations are found among the network devices. If the procedure succeeds, k is the estimated number of individuals in the location.

Furthermore, various commercially-available analytical software programs may also be used to solve for the meaningful principal components from the exemplary matrix X 150 shown in FIG. 1 using PCA. One such commercially available PCA analytic software is PROC FACTOR by SAS. A detailed description of PCA in general and some examples on how to use SAS's PROC FACTOR can be found here: http://support.sas.com/publishing/pubcat/chaps/55129.pdf (entitled: Chapter 1—PRINCIPAL COMPONENT ANALYSIS). Accordingly, a number of principal components with significant eigenvalues may be found using the SAS software which would represent k estimated number of individuals associated with a location, as described above.

According to the present principles, once a matrix such as the matrix X 150 shown in FIG. 1 is constructed, another exemplary method may be used to determine or cluster the set of devices associated with each of the k individuals. For example, for every pair of devices a and b associated with a location, we define a correlation or a distance measurement, m(a, b), that yields a real number representing how many time slots the two devices, a and b, together are either on or off during the same time lot. A number of distance metrics may be used. As an exemplary embodiment, we use the following (Equation 1):

$$m ( a , b ) = 1 - \frac{\sum {X}_{a} ⊕ {X}_{b}}{N}$$

where a is, for example, a row vector shown in the matrix X 150 in FIG. 1 (e.g., row 1 151 representing Device 1), and h is for example, another row vector shown in matrix X 150 (e.g., row 2 152 representing Device 2). It is easy to see that, therefore, the measurement, m, is small if a and b tend to be active at the same time, and high otherwise. Given D and m, one may carry out a clustering of the devices. One exemplary method to accomplish this clustering is by using k-means clustering, with a cluster parameter k+1. This returns k clusters that correspond to the k distinct individuals in the home, and an additional cluster that can capture devices in the home that are not personal (e.g., shared devices such televisions, game consoles, and etc.). Of course, other clustering methods besides k-means clustering may also be used, as is well known in the art.

According to another exemplary embodiment of the present principles, the clustering of devices in a location as described herewith may be carried out by first filtering out devices that are unlikely to be belonging to an individual, e.g., based on MAC addresses of the network devices. This can be done because MAC addresses are typically assigned in a factory by a manufacturer based on the product type and/or name of the manufacturer. That is, if an MAC address indicates that a device is a 80-inch television made by Sony, it is probably a shared family device and not personal. In addition, the MAC filtering may be carried out either before or after, e.g., the PCA described above is performed.

FIG. 3 illustrates an exemplary process 300 according to the present principles. At step 310, an electronic gateway device such as a local gateway 210 and/or a network based gateway device 260 monitors a network associated with a location. This information is used for producing a plurality of data entries (e.g., entries in matrix X shown in FIG. 1) that are applicable to a plurality of time slots N in FIG. 1. For a given data entry applicable to a corresponding time slot, the data entry is used to identify a network device exhibiting network activity during the given time slot. That is, e.g., a given data entry could be either a 1 or 0 as shown in FIG. 1 and as described above.

At step 320 of FIG. 3, a correlation analysis is applied to the data entries for determining a number of groups of the plurality of network devices, each group comprising a subset of the plurality of network devices, wherein the subset of the plurality of network devices having among them correlated network activity, as described previously. Accordingly, the number of network users or the population associated with the location is determined by the number of groups being indicated.

As indicated at step 330, the correlation analysis used in step 320 may be, for example, a principal component analysis as previously described. Alternatively, the correlation analysis in step 320 may be by clustering of the network devices based on a distance measurement performed between two rows of the data entries as shown in Equation 1 as previously described, as shown at step 340.

At step 350, MAC addresses of the plurality of network devices may be additionally filtered, at various stages of the process 300, including before and/or after the correlation analysis such as a principal components analysis shown at step 320 and/or step 330. Additionally, a processor capable of executing the exemplary process 300 shown in FIG. 3 may be, e.g., either a processor residing in a gateway device and/or a processor residing in an analysis server (e.g., 231, 280, 261, and/or 281 of FIG. 2).

The foregoing has provided by way of exemplary embodiments and non-limiting examples a description of the method and systems contemplated by the inventors. It is clear that various modifications and adaptations may become apparent to those skilled in the art in view of the description. However, such various modifications and adaptations fall within the scope of the teachings of the various embodiments described above.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereof, the embodiments disclosed may be practiced otherwise than as specifically described and claimed. The present embodiments are directed to each individual feature, system, article, material and/or method described herein. In addition, any combination of two or more such features, systems, articles, materials and/or methods, if such features, systems, articles, materials and/or methods are not mutually inconsistent, is included within the scope of the present embodiment.

1. A method performed by an electronic apparatus for estimating a number of network users using a plurality of network devices associated with a location, comprising:
monitoring a network, via a processor, for producing a plurality of data entries that are applicable to a plurality of time slots, a given data entry applicable to a corresponding time slot and is used to identify a network device exhibiting network activity during the given time slot; and
estimating, via the processor, the number of network users associated with the location wherein the estimating is based on a result of a correlation analysis of the data entries for determining a number of groups of the plurality of network devices, each group comprising a subset of the plurality of network devices, wherein the subset of the plurality of network devices having among them correlated network activity; and wherein the number of groups being indicative of the number of network users associated with the location.

2. The method of claim 1 wherein the correlation analysis comprises a principal components analysis.

3. The method of claim 2 wherein the number of groups is determined by a number of principal components each having a corresponding eigenvalue greater than a value based on the principal component analysis.

4. The method of claim 3 wherein the value is 1.

5. The method of claim 1 wherein the correlation analysis comprises clustering the network devices based on a distance measurement performed between two rows of the data entries.

6. The method of claim 5 wherein the distance measurement is based on exclusive OR of the two rows of the data entries.

7. The method of claim 6 wherein the electronic apparatus comprises one of a gateway device residing in the location of the network users and a gateway device residing in an Internet service provider location.

8. The method of claim 7 further comprising filtering out MAC addresses of the plurality of network devices.

9. The method of claim 4 further comprising filtering out MAC addresses of the plurality of network devices either before or after the principal components analysis.

10. An electronic apparatus for estimating a number of network users using a plurality of network devices associated with a location, comprising
a processor configured to monitor a network for producing a plurality of data entries that are applicable to a plurality of time slots, a given data entry applicable to a corresponding time slot and is used to identify a network device exhibiting network activity during the given time slot; the processor is further configured to estimate the number of network users associated with the location wherein the estimation is based on a result of a correlation analysis to the data entries for determining a number of groups of the plurality of network devices, each group comprising a subset of the plurality of network devices, wherein the subset of the plurality of network devices having among them correlated network activity; and wherein the number of groups being indicative of the number of network users associated with the location; and
a memory configured to store the estimated number of network users associated with the location.

11. The electronic apparatus of claim 10 wherein the correlation analysis comprises a principal components analysis.

12. The electronic apparatus of claim 11 wherein the number of groups is determined by a number of principal components each having a corresponding eigenvalue greater than a value based on the principal component analysis.

13. The electronic apparatus of claim 12 wherein the value is 1.

14. The electronic apparatus of claim 10 wherein the correlation analysis comprises clustering the network devices based on a distance measurement performed between two rows of the data entries.

15. The electronic apparatus of claim 14 wherein the distance measurement is based on exclusive OR of the two rows of the data entries.

16. The electronic apparatus of claim 15 wherein the electronic apparatus comprises a gateway device residing in one of the location of the network users and an Internet service provider location.

17. The electronic apparatus of claim 16 wherein MAC addresses of the plurality of network devices are filtered out.

18. The electronic apparatus of claim 17 wherein MAC addresses of the plurality of network devices are filtered out either before or after the principal components analysis.

19. A computer program product stored in a non-transitory computer-readable storage medium for estimating a number of network users using a plurality of network devices associated with a location comprising computer-executable instructions for:
monitoring a network for producing a plurality of data entries that are applicable to a plurality of time slots, a given data entry applicable to a corresponding time slot and is used to identify a network device exhibiting network activity during the given time slot; and
estimating the number of network users associated with the location wherein the estimating is based on a result of a correlation analysis of the data entries for determining a number of groups of the plurality of network devices, each group comprising a subset of the plurality of network devices, wherein the subset of the plurality of network devices having among them correlated network activity; and wherein the number of groups being indicative of the number of network users associated with the location.
